(19) United States
(12) Patent Application Publication
(10) Pub. No.: US 2026/0200238 A1
(43) Pub. Date: Jul. 16, 2026

(54) A METHOD FOR ADJUSTING A PHASE DIFFERENCE BETWEEN PRINTING UNITS OF A PRINTING DEVICE AND A PRINTING DEVICE

(71) Applicant: BOBST MEX SA, Mex (CH)

(72) Inventor: Matthieu RICHARD, Remoray (FR)

(73) Assignee: BOBST MEX SA, Mex (CH)

(21) Appl. No.: 19/135,183

(22) PCT Filed: Dec. 13, 2023
(86) PCT No.: PCT/EP2023/085647

§ 371 Date: Jun. 3, 2025

(30) Foreign Application Priority Data
Dec. 23, 2022 (EP) 22216278.6

(51) Int. Cl. B41J 2/21; B41M 3/00; G06T 7/00

(52) U.S. Cl. CPC B41J 2/2135; B41J 2/2103; B41M 3/008; G06T 7/001; G06T 2207/10024; G06T 2207/30144

(57) ABSTRACT

A method is disclosed for adjusting a phase difference between at least a first printing unit (12) of a printing device (10) and a second printing unit (14) of the printing device (10), each printing unit (12, 14) comprising at least one printing head (16), wherein the at least first and second printing units (12, 14) are arranged with a distance to each other with respect to a paper travel direction (20). Moreover, a printing device (10) is disclosed.

The present invention refers to a method for adjusting a phase difference between at least a first printing unit of a printing device and a second printing unit of the printing device. The invention furthermore refers to a printing device.

Printing devices usually have several printing units for printing different colour planes. A print medium, in particular a paper web, passes the different printing units subsequently.

The alignment of the colour planes has to be very accurate in order to ensure a high printing quality. In particular, a colour misalignment that exceeds 50 microns affects the print quality in a noticeable way. Thus, there is a need to control the register of the printing units with regard to horizontal and vertical alignment as well as with regard to skewing. The vertical direction (or “Y” direction) is aligned with the paper travel direction, while the horizontal direction (or “X” direction) is aligned with the direction transverse to the paper travel direction.

The alignment of the printing units usually occurs in an automated manner. For example, an image printed by a printing head of a printing unit is captured and depending on the position of the image, it is estimated whether the printing head is properly aligned or not.

US 2012/0092403 A1 describes a printing device with print heads that are arranged in units, wherein each unit prints a different colour. To detect and compensate a misalignment between the print heads of the different units, a vernier pattern is used. A position of a dense region in the Vernier pattern indicates a relative vertical misalignment between the print heads.

However, the known methods are not satisfactory regarding the required precision or complexity.

It is thus an object of the present invention to enable a sufficient phase adjustment between the printing units of printing device.

To summarize the principles detailed below, the object is achieved by performing an alignment along the vertical direction (i.e. the paper travel direction). To ease the understanding of the reader, we overview the principle (in an incomplete manner) in the next paragraph, and describe it extensively in the text that follows.

The alignment along the vertical direction is performed by printing a periodic signal made of horizontal lines with each printing unit, using a first period with the first printing unit and a second, different, period with the second printing unit. The period is given by the distance between two adjacent horizontal lines. The result is “read” by detecting the extrema of a third signal along the vertical direction.

This object is achieved by a method for adjusting a phase difference between at least a first printing unit of a printing device and a second printing unit of the printing device, each printing unit comprising at least one printing head, wherein the at least first and second printing units are arranged with a distance to each other with respect to a paper travel direction. In particular, there is no overlap between the printing heads of different printing units in a direction along the paper travel direction, i.e. the vertical direction. One method step comprises printing a first pattern with the first printing unit, the first pattern comprising a plurality of parallel lines extending in a direction transverse to the paper travel direction and equally spaced with respect to each other along the paper travel direction by a first distance. In particular, the first pattern constitutes a first periodic signal with a first frequency. A further method step comprises printing a second pattern overlapping the first pattern with the second printing unit, the second pattern comprising a plurality of parallel lines extending in a direction transverse to the paper travel direction and equally spaced with respect to each other along the paper travel direction by a second distance, wherein the second distance is different from the first distance. In particular, the second pattern constitutes a second periodic signal with a second frequency. After printing the first and the second pattern, a third periodic signal that results from superimposing the first and the second periodic signal is measured with a camera of the printing device and a phase difference between the first printing unit and the second printing unit is evaluated based on the course of the measured third periodic signal, wherein a reference signal is printed which has the same frequency as the third periodic signal and the phase of the third periodic signal is detected by comparing the third signal to the reference signal. The method further comprises adjusting a phase difference by adjusting the timing of ink dispensation from at least one of the first and the second printing unit.

It is assumed that the interaction of light with ink is approximately multiplicative. Thus, the third signal, or at least part of the third signal, is the result of a multiplication of the first signal with the second signal.

By means of the inventive method, a particularly high alignment precision can be achieved with respect to a phase difference of the first printing unit and the second printing unit. The alignment precision can be even higher than the pixel size of the camera. For example, an alignment precision of 10 μm to 50 μm can be achieved with a camera that has a pixel size of 90 μm. The pixel size in the sense of the application means a pixel size of the printed image that is projected on an individual pixel of the camera sensor. In other words, the pixel size is a square of the printed image that can be individually distinguished by the camera.

For measuring the third periodic signal, a peak of the third periodic signal is detected by coarse reading of the image. This allows determining a very precise phase difference between the first periodic signal and the second periodic signal. In particular, the phase difference between the first periodic signal and the second periodic signal determines the position of the peak of the third periodic signal. Also, the phase difference between the first periodic signal and the second periodic signal corresponds to the phase mismatch between the printing units, or, in other words, the phase difference corresponds to a mismatch in alignment of the colour planes printed by the different printing units.

In particular, the phase of the third signal is detected by comparing the positions of the minima and maxima of the third signal to the reference signal. The phase of the reference signal is known and is, for example, zero. In other words, the reference signal is the calculated superimposed signal which would be achieved by superimposition of a first and second signal without any phase difference.

When a phase difference between the first periodic signal and the second periodic signal is zero, the distance between the printing units is properly adjusted.

The third periodic signal runs in a direction along the paper travel direction.

The method is based on the idea that a first signal and a second signal are not directly measured, but a third signal superimposed of the first and the second signal is measured to evaluate a relation, in particular a phase difference between the first signal and the second signal.

In particular, a phase difference is determined by comparing the measured superimposed signal with a calculated superimposed signal. The calculated superimposed signal represents a signal which would be achieved by superimposition of a first and second signal without any phase difference.

According to one aspect, the first distance and/or the second distance are defined such that the first signal respectively the second signal is detected as continuously varying signal by the camera. In other words, the camera sees no explicit and clear gaps between the lines, it only sees a variation in the signal amplitude that looks like a set of blurred lines. Thus the signal is not binary but is made of a smooth variation of greyscale values. Thereby, the first and/or the second signal may be detected as sinusoidal signals and not as separate lines. This can be done thanks to the fact that the edges of the printed lines spread. For example, the thickness of a line printed by inkjet is typically 30 μm, but the photons undergo multiple reflections within the paper prior to exiting the paper and reaching the camera. Some additional blur may be caused by the optics and limited resolution of the camera sensor. Consequently, the printed lines appear fuzzy with a bigger thickness than 30 μm. Both effects combined result in the possibility to measure a superimposed third signal when the first and the second distance is chosen respectively. The third signal may also be treated as a sinusoidal signal.

According to an exemplary embodiment, we print several lines per millimetre, and choose the difference between the first distance and the second distance to be a few percent. The frequency of the third signal is such that it can be easily detected. For example, the third signal has a frequency of five to ten repetitions per cm along the paper travel direction.

The third periodic signal may be used by measuring the position of at least one maximum and/or the position of at least one minimum of the signal in a paper travel direction. Thereby, measuring the third signal is particularly easy.

In addition to the first pattern, a first coarse pattern may be printed by the first printing unit and a second coarse pattern may be printed by the second printing unit, wherein a coarse adjustment is performed on basis of the position of the first and second coarse pattern with respect to each other, wherein the precision of the coarse adjustment is at least half of the first distance.

Because the first and second signals are periodic signals, there is an indetermination of the position given by the period of the signal. The coarse patterns are used to alleviate this indetermination. For example, if the second signal is shifted by a distance equal to the first distance, the third signal will be the same. By doing the coarse adjustment, such indetermination can be avoided. In particular, the coarse adjustment has to be done with an accuracy of at least half of the first distance to alleviate the indetermination of the first misalignment measurement. Thereby, a particularly reliable phase adjustment and alignment of the printing units can be achieved.

The coarse pattern may, for example, be similar to the first and second pattern but using thicker lines with a larger distance between said lines, without overlapping. From these lines, a position mismatch between the printing units is computed (by any suitable method; here the gaps between the lines are clearly visible). This position mismatch has a precision which is worse than the precision obtained by the method using thinner lines. In particular the required precision obtained with the thicker lines must be smaller than half the first distance (between two thin lines). As an alternative, standard alignment marks instead of thick repeating lines could be used.

According to one aspect, a first and a second pattern is printed on each of the left side and the right side of a printing head of the printing unit. By comparing the third signal resulting from the superimposed signals of the first and second patterns on the left and the right side of a printing head, a rotation misalignment can be detected and corrected accordingly. In particular, a rotation is detected when a phase of the third signal on the left and right side of the printing unit is different. The rotation misalignement is corrected by physically turning the printing head, or by adjusting the dispensing of the ink differently on the right side of the printing head compared to the left side.

According to another aspect, a first and a second pattern is printed on each of the left side and the right side of a printing bar of the printing unit. By comparing the third signal resulting from the superimposed signals of the first and second patterns on the left and the right side of the printing bar, a skewing misalignment along direction of paper movement can be detected and corrected accordingly. In particular, a skewing along a direction of paper movement is detected when a phase of the third signal on the left and right side of the printing bar is different. The skewing can be corrected by correcting the timing of dispensing of the ink across the print bar.

The object is further achieved by a printing device, in particular an ink jet printing device, comprising at least a first printing unit and a second printing unit, each printing unit comprising at least one printing head, a camera being configured to capture an image printed by the printing units, and a control unit configured for processing the image captured by the camera, wherein the printing device is configured to perform the inventive method, and wherein the control unit is configured to evaluate a phase difference between the first printing unit and the second printing unit.

Further features and advantages can be derived from the following description and the enclosed drawings. In the drawings:

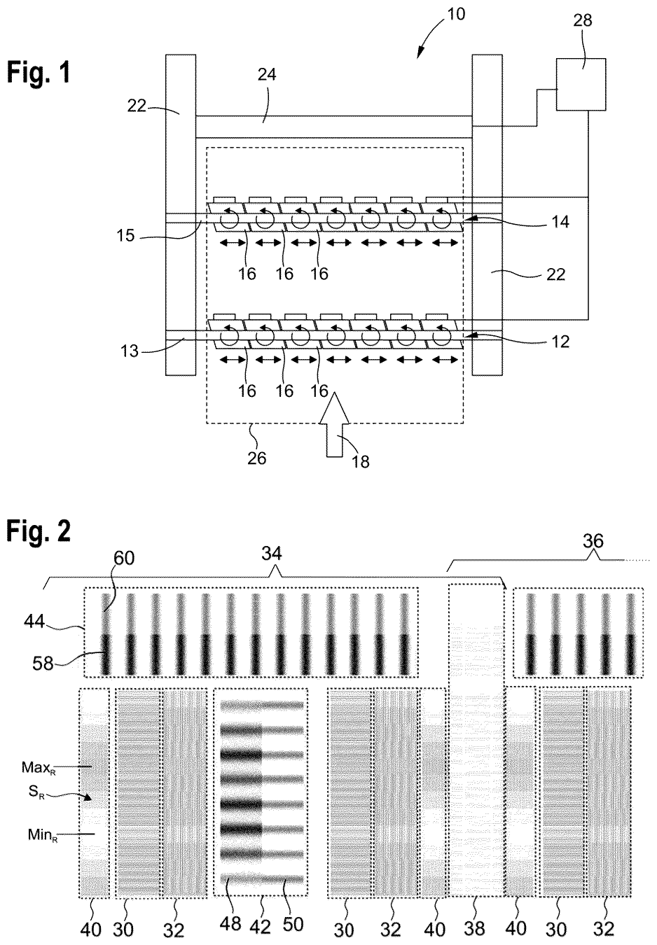

FIG. 1 shows a printing device in a schematic view,

FIG. 2 schematically shows an image printed by the printing device,

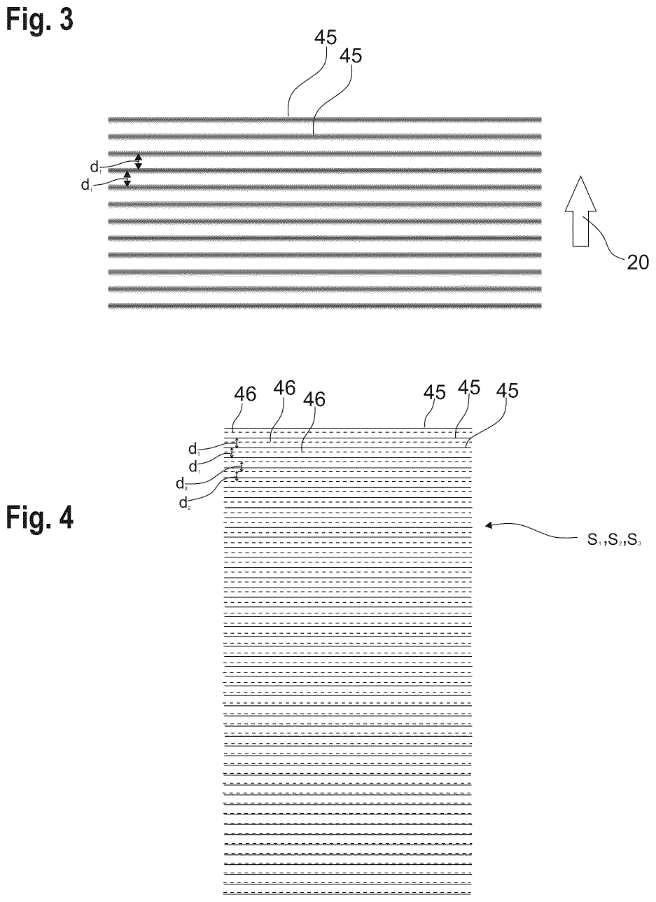

FIG. 3 shows an intermediate stage when printing a section of the image of FIG. 2,

FIG. 4 shows a section of the image of FIG. 2,

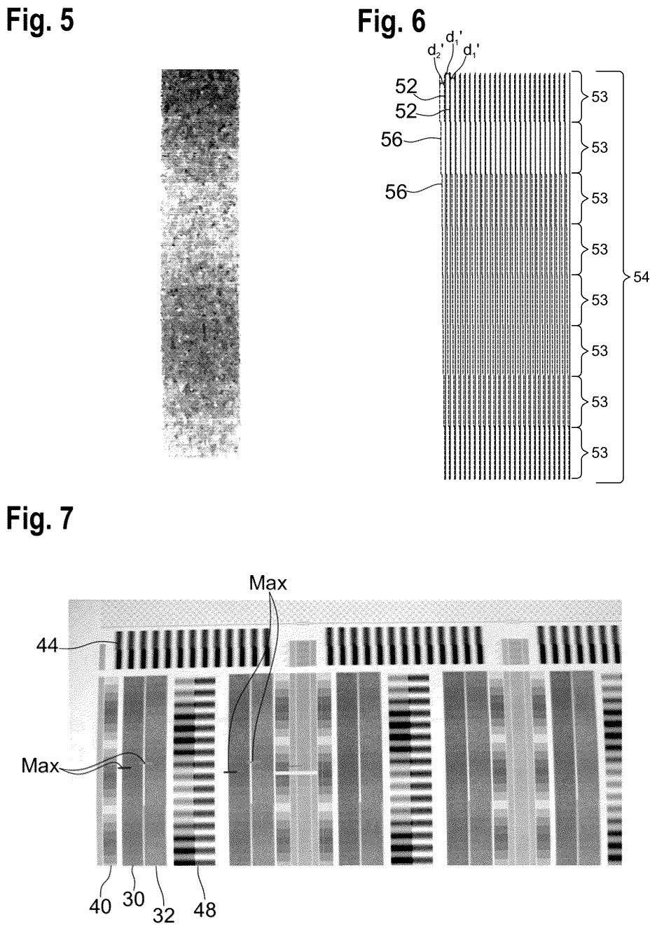

FIG. 5 shows the section of FIG. 4 as measured by a camera,

FIG. 6 shows a further section of the image of FIG. 2, and

FIG. 7 shows a photograph of the image printed by the printing device as schematically visualized in FIG. 2.

FIG. 1 schematically shows a printing device 10 having a first printing unit 12 and a second printing unit 14. The printing device 10 is an ink jet printing device, in particular a digital printer.

The first printing unit 12 and the second printing unit 14 are configured for printing different colour planes. For reasons of simplicity, only two printing units 12, 14 are depicted in FIG. 1. However, the printing device 10 can have more than two printing units 12, 14.

The printing units 12, 14 are arranged with a distance to each other with respect to the paper travel direction. In particular, there is no overlap between the printing units 12, 14 along the paper travel direction.

Each printing unit 12, 14 has a plurality of printing heads 16. The printing heads 16 are aligned along a line, which constitutes a printing bar 13, 15, respectively.

The printing heads 16 are attached to bars 13, 15 extending transverse to an advance direction of the printing device 10.

The printing heads 16 can be moved along the bar 13, 15 or rotated as indicated by arrows in FIG. 1 at least to a certain extend.

The advance direction corresponds to a paper travel direction and is indicated in FIG. 1 by arrow 20.

The bars 13, 15 are attached to a machine frame 22 of the printing device 10.

All the printing heads 16 attached to one bar 13, 15 are configured to print a single colour.

The printing device comprises a camera 24, which is for example a 2D-camera or a line camera configured to capture an image of the paper printed by the printing units 12, 14.

The camera 24 covers the whole width of the printing units 12, 14. In particular, the camera 24 extends over the whole width of a paper 26 that is processed in the printing device 10.

The camera 24 is positioned downstream of the printing units 12, 14 with respect to the paper travel direction 20.

The printing device 10 further comprises a control unit 28 configured for processing the image captured by the camera 24.

The control unit 28 is further configured for determining a phase difference or misalignment between the printing units 12, 14.

In particular, the control unit 28 is configured for determining a phase difference or misalignment between the printing units 12, 14 based on an image printed by the printing device 10, as will be described in further detail with respect to the following figures.

FIG. 2 shows an image printed by the printing device 10, in particular by the first printing unit 12 and the second printing unit 14. Thus, the image contains two different colours, which in FIG. 2 are two different shades of grey. For example, the two colours are black and magenta.

The image has different sections, wherein different patterns are printed in different sections. However, some sections have the same pattern.

Sections of the image which are designated with the same reference signs are alike, i.e. have the same pattern.

The image has phase alignment sections 30 which are adapted for enabling adjustment of a phase difference.

Furthermore, the image has horizontal alignment sections 32 which are adapted for enabling an alignment of the printing units 12, 14 with respect to a direction transverse to the paper travel direction 20.

In the depicted embodiment, a phase alignment section 30 as well as a horizontal alignment section 32 is printed twice by every printing head 16, in particular on each of the left side and the right side of a printing head 16 of the respective printing unit 12, 14.

Areas 34, 36 covered by one printing head 16 in the direction transverse to the paper travel direction are designated in FIG. 2. At the transition between two printing heads 16 of one printing unit 12, 14, the printing heads 16 overlap to some extent. In this area, an overlap section 38 is printed. The overlap section 38 allows an in-colour adjustment, in particular an adjustment of the printing heads 16 of one printing unit 12, 14 with respect to each other.

Furthermore, the image comprises a reference section 40 which in the depicted embodiment is printed twice by every printing head 16, on each of the left and the right side of the printing head 16.

Moreover, the image comprises a coarse phase alignment section 42. The coarse phase alignment section 42 is adapted for enabling a coarse adjustment of a phase difference prior to a more precise adjustment.

Moreover, the image comprises a coarse horizontal alignment section 44. The coarse horizontal alignment section 44 is adapted to enable a coarse alignment of the printing units 12, 14 with respect to a direction transverse to the paper travel direction 20 prior to a more precise adjustment.

In the following, the different sections 30, 32, 38, 40, 42, 44 as well as a method for adjusting a phase difference between the first printing unit 12 and the second printing unit 14 based on the printed image, in particular by processing the printed image by means of the control unit 28, will be described in more detail.

Moreover, a method for aligning the first printing unit 12 and the second printing unit 14 with respect to a direction transverse to a paper travel direction based on the printed image, in particular by processing the printed image by means of the control unit 28, will be described.

With reference to FIGS. 2 to 5, a method for adjusting a phase difference between the first printing unit 12 and the second printing unit 14 will be described.

FIGS. 3 to 5 show the phase alignment section 30 of the image.

When printing the phase alignment section 30, in a first step a first pattern which is depicted in FIG. 3 is printed with the first printing unit 12. The first pattern comprises a plurality of parallel lines 45 extending in a direction transverse to the paper travel direction 20 and equally spaced with respect to each other along the paper travel direction 20 with a first distance d₁.

The first pattern constitutes a first periodic signal S₁ with a first frequency f₁.

The distance d₁ is kept constant along the first pattern.

In a following step visualized in FIG. 4, a second pattern overlapping the first pattern is printed with the second printing unit 14, the second pattern comprising a plurality of parallel lines 46 extending in a direction transverse to the paper travel direction 20 and equally spaced with respect to each other along the paper travel direction with a second distance d₂, wherein the second distance d₂ is different from the first distance d₁.

The second pattern constitutes a second periodic signal S₂ with a second frequency f₂.

In FIGS. 3 and 4, the lines 45 and 46 are recognizable as separate horizontal lines for better understanding. In particular, to better distinguish the first and second lines 45, 46 from each other, the lines 45 are depicted as continuous lines and the lines 46 are depicted as dashed lines.

However, the first distance d₁ and the second distance d₂ are defined such that the first signal S₁ respectively the second signal S₂ is detected as continuously varying signal by the camera 24, for example by printing several lines per mm.

In particular, S₁ and S₂ look like a periodic signal that is sinusoidal in the computation. Also, the interaction of the light with the ink on paper being approximately multiplicative, the third signal is the result of a multiplication of the first signal with the second signal. Thus, the frequency of the third signal is the difference between the frequency of the first signal and the frequency of the second signal. In other words, since the third signal stems from the superposition of the first and second signal. The period of the third signal is the (smallest) distance between two locations where the first and the second signal overlap in the same manner, for example the distance between two locations where a line of the first signal is aligned with a line of the second signal. Thus, the period of the third signal is chosen by setting the frequency of the first signal and the frequency of the second signal to obtain a predetermined frequency for the third signal. For example, if the period of the first signal S₁ and the second signal S₂ differ by 10%, the period of the third signal S₂ is 10 times larger than the period of the first signal and thus may be made larger than 1 mm. It can then be easily detected by the camera.

For example, the first distance d₁ and/or the second distance d₂ are between 100 and 300 μm.

In one specific embodiment, the size of an ink drop from a printing head 16 i.e. the thickness of a line 45, 46 is 30 μm. However, at this scale, the edge of the printed lines 45, 46 spread, due to the camera optics and sensor, and due to the photons undergoing multiple reflections within the paper before leaving the paper and reaching the camera such that the lines 45, 46 appear to have a larger thickness and appear fuzzy. Thus, by printing several lines per mm, the signal that is recorded by the camera 24 can be considered approximately as a continuously varying signal (thus not a binary signal).

When the first and the second pattern i.e. the first and the second signal S₁, S₂ are superimposed, a third periodic signal S₃ results.

The third periodic signal S₃ that is resulting from superimposing the first and the second periodic signal S₁, S₂ is measured with the camera 24 of the printing device 10 and a phase difference between the first printing unit 12 and the second printing unit 14 is evaluated based on the measured third periodic signal S₃. The phase is the position of the peak of the signal.

FIG. 5 shows the signal S₃ as detected by the camera 24.

In particular, the phase of the third signal S₃ is determined to derive the value of the phase of the second signal S₂.

From the phase of the second signal S₂, a phase difference between the first signal S₁ and the second signal S₂ can be determined.

If a phase difference is detected, the phase difference is adjusted by adjusting the timing of ink dispensation from at least one of the first printing unit 12 and the second printing unit 14.

The pixel size of the camera 24 is for example 90 μm. Thus, the distance d₃ represents approximately 16 pixels.

By detecting the position of the maximum value of the third signal S₃ with a precision of one pixel, the value of the phase difference between the two signals S₁, S₂ can be evaluated with a precision of approximately 1/10 of a pixel. In other words, according to the described method, a phase difference between the two signals S₁, S₂ can be detected with a particularly high accuracy.

The third periodic signal S₃ is, for example, measured by measuring the position of maxima and the minima of the signal S₃ in a paper travel direction. Knowing the position of the maxima and the minima of the third signal S₃, the phases of the third signal S₃ can be evaluated in an easy manner.

The maxima and minima of the third signal S₃ are detected by comparing the third signal S₃ to a reference signal S_{R}.

In particular, the reference signal S_{R} is printed in the reference section 40.

The reference signal S_{R} has the same frequency as the third periodic signal S₃. In particular, the phase of S_{R} is set to zero, which corresponds to the phase of signal S₃ when signals S₁ and S₂ are aligned. Thus, when S₃ and S_{R} are aligned, the colour planes of the printing units are also aligned (along direction Y). The use of the reference signal S_{R} allows to operate without determining with precision the distance travelled by the paper between the printing units and the camera.

The phase of the third periodic signal S₃ is detected by comparing the third signal S₃ to the reference signal S_{R}, in particular by comparing the positions of the minima and maxima of the third signal S₃ to the positions of maxima and minima of the reference signal S_{R}. If the minima and maxima of the third signal S₃ are shifted with respect to the maxima and minima of the reference signal S_{R}, a phase difference is detected.

The positions of a maximum Max_{R} and a minimum Min_{R} of the reference signal S_{R} are indicated in FIG. 2.

By means of a phase alignment section 30 being present on each of the left side and the right side of a printing head 16, as depicted in FIG. 2, it is possible to detect a rotation of the printing head 16 respectively the printing units 12. In particular, a rotation is present when the phase difference between the first and second signal S₁, S₂ is different in the two alignment sections 30.

By means of a phase alignment section present at the leftmost and rightmost part of the printed paper, it is possible to detect a skewing of the printing bar 13 with respect to printing bar 15. Skewing may be caused by defect of parallelism between the different printing bars 13, 15.

Before a fine adjustment of the phase difference is done, a coarse phase adjustment is performed.

The coarse phase adjustment is done with an accuracy of at least half of the first distance d₁ in order to avoid indetermination of the position given by the period of the signals S₁, S₂.

The coarse phase adjustment is made by means of a first coarse pattern and a second coarse pattern printed in the coarse phase alignment section 42, as depicted in FIG. 2. The first coarse pattern is printed by the first printing unit 12 and consists of parallel lines 48 extending in the direction transverse to the paper travel direction and the second coarse pattern is printed by the second printing unit 14 and consists of parallel lines 50 extending in the direction transverse to the paper travel direction. Since the coarse phase adjustment uses thicker lines, we do not superpose them: we just compute the position of every line. For coarse alignment, we do not even need to print periodic signals. A simple alignment mark printed by each printing unit would also be a possible alternative

The coarse adjustment is performed on basis of the position of the first and second coarse pattern with respect to each other, wherein the precision of the coarse adjustment is at least half of the first distance d₁.

By means of a phase alignment section 30 being present on each of the left side and the right side of a printing head 16, a rotation of the printing head can be detected. In particular, a rotation is present if the phase of the third signal S₃ on the left and the right side of the printing head 16 is different.

Referring to FIG. 6, a horizontal alignment section 32 is described in more detail.

In the horizontal alignment section 32, a first pattern is printed with the first printing unit 12. The first pattern comprises a plurality of parallel lines 52 extending in a direction parallel to the paper travel direction 20 and equally spaced with respect to each other in the direction transverse to the paper travel direction 20 with a first distance d₁′.

The lines 52 of the first pattern extend continuously over at least a first section 54 in the paper travel direction 20. The first pattern constitutes a first signal, in particular a continuous signal S₁′. In other words, the signal S₁′ has a constant phase.

Moreover, a second pattern overlapping the first pattern is printed with the second printing unit 14. The second pattern comprises a plurality of parallel lines 56 extending in a direction parallel to the paper travel direction 20 and arranged with an equal distance d₂′ with respect to each other which is identical to the first distance d₁′.

The lines 56 are depicted as dashed lines in FIG. 6 to better distinguish the lines 52, 56 from each other.

For example, the first distance d₁′ and the second distance d₂′ are between 100 and 300 μm.

The parallel lines 56 of the second pattern constitute a plurality of bands 53. In particular, a band 53 is a section along the first section 54 that are distinguishable from each other due to a different horizontal position of the lines 56 of the second pattern.

The bands 53 are arranged subsequent to each other with respect to the paper travel direction 20, in particular with respect to the vertical direction Y. In the depicted embodiment, the bands 53 directly adjoin each other in the vertical direction, i.e. there is no vertical distance between the bands 53.

However, there can be a vertical distance between the single bands 53. In that case, the bands 53 can be digitally reassembled by means of the control unit 28 for further analysis.

The position of the lines 56 of the second pattern is shifted between the different bands 53. There are at least three bands, thus the second pattern is shifted at least twice with respect to a direction transverse to the paper travel direction in the first section. In other words, the position of the lines 56 is modulated in the direction transverse to the paper travel direction. In other words, the position of the lines 56 is modulated across bands 53.

In particular, the lines 56 of the second pattern that define the bands 53 are shorter than the lines 52 of the first pattern.

In the section 54 depicted in FIG. 6, the position of the lines 56 of the second pattern is shifted seven times along the horizontal direction X in the section 54.

The second pattern constitutes a second signal being a periodic signal S₂′.

Due to d₂′ being equal to d₁′, the first signal S₁′ and the second signal S₂′ have the same frequency along the horizontal direction X.

Due to the lines 56 of the second signal S₂′ being shifted in the section 54, the second signal S₂′ has a varying phase with respect to S₁′ across the bands 53. Within a single band, the phase of the second signal S₂′ compared to the phase of the first signal S₁′ is constant.

A third signal S₃′ being a periodic signal along vertical direction Y is resulting from superimposing the first signal S₁′ and the second signal S₂′. Thus, the third signal stems from the variation of the appearance of the bands 53. The amount of shift (i.e. the phase difference) between S₁′ and S₂′ across the bands 53 determines the period of signal S₃′. The phase of signal S₃′ is determined by the phase difference between signal S₁′ and S₂′ in a predetermined band 53.

Based on the course of the measured third signal S₃′, a misalignment between the first printing unit 12 and the second printing unit 14 in the direction transverse to the paper travel direction 20 is evaluated. In particular, based on the on the position of the extrema of signal S₃′, the phase relation between S₁′ and S₂′ can be computed.

For example, the lines 56 shift once every centimetre. In other words, the height of the bands 53 is one centimetre in this example.

If a misalignment is detected, the misalignment is adjusted by shifting the first printing unit 12 and/or the second printing unit 14 in a direction transverse to a paper travel direction 20.

As described with respect to the phase alignment, a coarse alignment can be made regarding a misalignment of the printing units 12, 14 in the direction transverse to the paper travel direction 20 by means of the coarse horizontal alignment section 44.

As the coarse phase alignment section 42, the coarse horizontal alignment section 44 consists of a first coarse pattern and a second coarse pattern printed in the coarse horizontal alignment section 44. The first coarse pattern is printed by the first printing unit 12 and may consist of thick parallel lines 58 extending in the direction along the paper travel direction 20 and the second coarse pattern is printed by the second printing unit 14 and may consists of thick parallel lines 60 extending in the direction along the paper travel direction. Contrary to the finer adjustment section 30, 32, the coarse adjustment is less critical and can be performed using any suitable, known method.

Same as for the coarse phases alignment, the horizontal course adjustment is performed on basis of the position of the first and second coarse pattern with respect to each other, wherein the precision of the coarse adjustment is at least half of the first distance d₁′.

Preferably, the first distance d₁ of the lines 45 extending in a direction transverse to the paper travel direction 20 and the first distance d₁′ of the lines 52 extending in a direction parallel to the paper travel direction 20 as well as the second distance d₂ of the lines 46 extending in a direction transverse to the paper travel direction 20 and the second distance d₂′ of the lines 56 extending in a direction parallel to the travel direction 20 are chosen such that the frequency f₃, f₃′ of both of the superimposed third Signals S₃, S₃′ is the same. Thereby, the same reference Signal S_{R} can be used to detect the maxima and minima of the respective third signal S₃, S₃′.

In FIG. 7, a photograph of the printed image is shown.

In the photograph, the position of a maximum Max of the third signal S₃, S₃′ in the phase alignment sections 30 and the horizontal alignment section 32 is marked.

In the depicted embodiment, the image comprises a phase alignment section 30 as well as a horizontal alignment section 32. However, depending on the requirements, it is possible that only a phase alignment section 30 or a horizontal alignment section 32 is printed.

1. A method for adjusting a phase difference between at least a first printing unit of a printing device and a second printing unit of the printing device each printing unit comprising at least one printing head , wherein the at least first and second printing units are arranged with a distance to each other with respect to a paper travel direction, the method comprising:
printing a first pattern with the first printing unit the first pattern comprising a plurality of parallel lines extending in a direction transverse to the paper travel direction and equally spaced with respect to each other along the paper travel direction with a first distance,
printing a second pattern overlapping the first pattern with the second printing unit the second pattern comprising a plurality of parallel lines extending in a direction transverse to the paper travel direction and equally spaced with respect to each other along the paper travel direction with a second distance, wherein the second distance is different from the first distance
measuring a third periodic signal along the paper travel direction that is resulting from superimposing the first and the second periodic signal with a camera,
evaluating the phase difference between the first printing unit and the second printing unit based on a course of the measured third periodic signal, wherein a reference signal is printed which has a same frequency as the third periodic signal and a phase of the third periodic signal is detected by comparing the third periodic signal to the reference signal and
adjusting the phase difference by adjusting a timing of ink dispensation from at least one of the first and the second printing unit.

2. The method according to claim 1, wherein the first distance and/or the second distance are defined such that the first signal respectively the second signal is detected as a continuously varying signal by the camera

3. The method according to claim 2, wherein the first distance and/or the second distance are between 100 and 300 μm.

4. The method according to claim 1, wherein additionally to the first pattern a first coarse pattern is printed by the first printing unit and additionally to the second pattern a second coarse pattern is printed by the second printing unit wherein a coarse adjustment is performed on basis of a position of the first and second coarse pattern with respect to each other, wherein a precision of the coarse adjustment is at least half of the first distance.

5. The method according to claim 1, wherein the third periodic signal is measured by measuring a position of at least one maximum and/or the position of at least one minimum of the signal in a paper travel direction.

6. The method according to claim 1, wherein a first and a second pattern is printed on each of a left side and a right side of a printing head of the printing unit

7. A printing device in particular an ink jet printing device, comprising:
at least a first printing unit and a second printing unit each printing unit comprising at least one printing head,
a camera being configured to capture an image printed by the printing units, and
a control unit configured for processing the image captured by the camera,
wherein the printing device is configured to perform the method according to claim 1, wherein the control unit is configured to evaluate a phase difference between the first printing unit and the second printing unit.
